(19) United States
(12) Patent Application Publication
(10) Pub. No.: US 2022/0019242 A1
(43) Pub. Date: Jan. 20, 2022

(54) SYSTEM AND METHOD FOR PLANNING TRAVELING PATH OF MULTIPLE AUTOMATIC HARVESTERS

(71) Applicant: FJ Dynamics Technology Co., Ltd, Xiangyang (CN)

(72) Inventors: Di Wu, Nanjing (CN); Yuan Yao, Nanjing (CN); QING-QUAN WANG, Xiangyang (CN); BO WANG, Xiangyang (CN); XIAO ZHANG, Xiangyang (CN); RUI CHEN, Xiangyang (CN); SHUN FAN, Xiangyang (CN)

(21) Appl. No.: 17/490,134

(22) Filed: Sep. 30, 2021

Related U.S. Application Data
(63) Continuation-in-part of application No. PCT/CN2019/106985, filed on Sep. 20, 2019.

(30) Foreign Application Priority Data
Apr. 9, 2019 (CN) 201910280738.0

(51) Int. Cl. G05D 1/02; G05D 1/00; A01B 79/00

(52) U.S. Cl. CPC G05D 1/0297; G05D 1/0219; G05D 1/0278; G05D 1/0255; G05D 1/0214; B60W 60/0025; G05D 1/0242; G05D 1/0016; A01B 79/005; G05D 2201/0201; G05D 1/0246

(57) ABSTRACT

A method for planning traveling paths for multiple automatic harvesters, includes performing detection and forming basic agricultural land information by a detection device and receiving the basic agricultural land information at a path planning module. The path planning module sets quantity setting information and divides harvesting areas of the multiple automatic harvesters and travel paths thereof.

### TECHNICAL FIELD

The present disclosure relates to automatic harvesters, and particularly to a system and a method for planning traveling path of multiple automatic harvesters, and a method for planning an optimal traveling path for simultaneous operation of multiple automatic harvesters.

### BACKGROUND

Nowadays, agricultural machinery industry has great momentum of development and current agriculture can be said to have got rid of the backward manner of farming by manpower, almost all links from sowing, plant protection to harvesting are completed by automatic harvester equipment, it can be said that modern agriculture has entered an era of mechanization. Further, in recent years, agricultural machinery has continued to develop and progress, in order to improve economic benefits of agriculture and promote a development of economic society, various agricultural machineries have sprung up like bamboo shoots after a rain, entered thousands of households in the countryside and brought countless benefits to farmers. In other words, modern agricultural machinery has played a certain role in improving labor productivity and promoting economic development. The mechanization of agriculture has improved efficiency of agricultural production, brought great convenience to the farmers, and played an important role in the rapid development of agriculture.

In particular, the automatic harvesters began to develop in the direction of unmanned aerial vehicles or autonomous driving. For unmanned aerial vehicles or autonomous driving, traveling path planning of the automatic harvester is one of the critical areas of focus. At the same time, with a development of domestic urbanization and merger of fertile land, large-scale production is not only a trend of foreign agriculture, but also a trend of domestic agriculture. In order to improve harvesting efficiency, in large farmland, multiple harvesters are usually utilized to operate simultaneously. However, when the harvesters are automatic harvesters, how do multiple automatic harvesters operate together, and how to plan a harvesting path of each automatic harvester is worth studying.

### SUMMARY

The present disclosure provides a system and a method for planning traveling paths of multiple automatic harvesters, the traveling paths of multiple automatic harvesters are planned, so that the automatic harvesters operate in cooperation with each other, to achieve a more efficient harvesting effect.

The present disclosure provides a system and a method for planning traveling paths of multiple automatic harvesters, manual, automatic, and semi-automatic settings can be used to enable the traveling path planning system to separately plan the most suitable traveling path for each automatic harvester, so as to ensure better harvesting efficiency and better operation distribution.

The present disclosure provides a system and a method for planning traveling paths of multiple automatic harvesters, obstacle information is acquired in advance to enable the automatic harvester to automatically avoid the obstacle during path planning or driving operation.

The present disclosure provides a system and a method for planning traveling paths of multiple automatic harvesters, when each of the automatic harvesters are harvesting in the respective harvesting areas, while acquiring obstacle information, the path planning can be modified to avoid obstacles, or the automatic harvester can be stopped directly. In particular, when the automatic harvester in the area replans the path, the automatic harvester in other areas maintains the originally set path when it does not affect the traveling path of the automatic harvester in other areas. In contrast, for example, when the automatic harvester in the area replans the path, when the traveling path of the automatic harvester in other areas is affected, the traveling path of the automatic harvester in other areas will be modified simultaneously.

The present disclosure provides a system and a method for planning traveling paths of multiple automatic harvesters, if there is a sudden obstacle, like a small animal or a person, the traveling path planning system will stop the automatic harvester to ensure safety.

The present disclosure provides a system and a method for planning traveling paths of multiple automatic harvesters, each time driving obstacle information is generated, the driving obstacle information sequentially transmitted to a path planning module for analysis to confirm whether a traveling path needs to be replanned.

The present disclosure provides a system and a method for planning traveling paths of multiple automatic harvesters, when a probe touches an obstacle, the obstacle analysis device determines whether the automatic harvester stops operating.

The present disclosure provides a system and a method for planning traveling paths of multiple automatic harvesters, an infrared detector is used to detect whether an obstacle suddenly breaks into the dangerous area in front of the automatic harvester.

The present disclosure provides a system and a method for planning traveling paths of multiple automatic harvesters, there is no need for precise parts and complicated structures, and the manufacturing process is simple and the cost is low.

To satisfy the above purposes and other purposes and advantages of the present disclosure, the present disclosure provides a method for planning traveling path of multiple automatic harvesters, which includes the following steps:

(a) a detection device detecting and forming basic farmland information; and

(b) dividing a harvesting area and forming a traveling path for each of the multiple automatic harvester after the basic farmland information is received and quantity determining information is determined.

According to the method of the present disclosure, transmitting the traveling path of each of the multiple automatic harvesters to a control device of each of the multiple automatic harvesters.

According to the method of the present disclosure, the basic farmland information is a group formed by a size, an area, a shape, coordinates, and a crop category of a farmland.

According to the method of the present disclosure, a detection device detecting and forming basic farmland information includes acquiring the basic farmland information by an automatic detection module through a fixed-point detection or a movement detection.

According to the method of the present disclosure, the automatic detection module is a module formed by an infrared sensor, a laser sensor, an ultrasonic sensor, an image sensor, or a GPS satellite positioning module.

According to the method of the present disclosure, dividing a harvesting area and forming a traveling path for each of the multiple automatic harvesters include detecting whether there is at least one obstacle; and generating previous obstacle information.

According to the method of the present disclosure, the traveling path of each automatic harvester has an initial driving point, each initial driving point is the same or different.

According to the method of the present disclosure, dividing a harvesting area and forming a traveling path for each of the multiple automatic harvesters include determining a quantity of the multiple automatic harvesters.

According to the method of the present disclosure, the traveling paths of the multiple automatic harvesters are not to be affected by each other.

According to the method of the present disclosure, dividing a harvesting area and forming a traveling path for each of the multiple automatic harvesters include determining a driving mode of each automatic harvester and generating driving information.

According to the method of the present disclosure, generating driving obstacle information in response that at least one obstacle is detected while the automatic harvesters are driving.

To satisfy the above purposes and other purposes and advantages of the present disclosure, the present disclosure further provides a system for planning traveling paths of multiple automatic harvesters, which includes:

a detection device acquiring basic farmland information; and

a path planning module comprising a quantity determining module and a control module; wherein the quantity determining module is connected with the control module and transmits quantity determining information to the control module, wherein the control module divides a harvesting area and a traveling path of each of the multiple automatic harvester according to the basic farmland information and the quantity determining information.

According to one embodiment of the present disclosure, the basic farmland information is a group formed by a size, an area, a shape, coordinates, and a crop category of a farmland.

According to one embodiment of the present disclosure, the detection device includes an automatic detection module connected with the control module, wherein the automatic detection module acquires the basic farmland information through a fixed-point detection or a movement detection, and transmits the basic farmland information to the control module.

According to one embodiment of the present disclosure, the automatic detection module is arranged on the automatic harvesters, an unmanned aerial vehicle, or a wireless detector, to perform movable detection.

According to one embodiment of the present disclosure, the automatic detection module is a module formed by an infrared sensor, a laser sensor, an ultrasonic sensor, an image sensor, or a GPS satellite positioning module.

According to one embodiment of the present disclosure, at least one manual determining module connected with the control module and inputting the basic farmland information into the control module.

According to one embodiment of the present disclosure, the detection device includes at least one obstacle pre-detecting device connected with the control module and acquiring previous obstacle information through a fixed-point detection or a movement detection, and transmitting the previous obstacle information to the control module.

According to one embodiment of the present disclosure, the detection device includes at least one driving obstacle detector connected with the control module, arranged on the automatic harvester, acquiring driving obstacle information in response that the at least one obstacle is detected while the automatic harvester is driving, and transmitting the driving obstacle information to the control module.

According to one embodiment of the present disclosure, the at least one driving obstacle detector includes a driving camera sensor, which includes a plurality of cameras surrounding the automatic harvester for acquiring images around the automatic harvester.

According to one embodiment of the present disclosure, the at least one driving obstacle detector includes at least one probe, which is arranged in front of the automatic harvester and detects whether there is at least one obstacle in front of the automatic harvester.

According to one embodiment of the present disclosure, the at least one driving obstacle detector includes at least one infrared detector, which is arranged in front of the automatic harvester for sensing people or animals who suddenly enter the front of the automatic harvester.

According to one embodiment of the present disclosure, the system is arranged on at least one of the multiple automatic harvesters, a remote control, a smart phone, a radio remote control, or a smart tablet host device.

These and other objectives, features, and advantages of the present disclosure are fully embodied by the following detailed description, drawings, and claims.

### BRIEF DESCRIPTION OF THE DRAWINGS

FIG. 1 is a logic schematic view of a preferred embodiment of a system for planning traveling path of multiple automatic harvesters according to the present disclosure.

FIG. 2 is a block diagram of a preferred embodiment according to the present disclosure.

FIG. 3 is a logic schematic view of a preferred embodiment of a detection device according to the present disclosure.

FIG. 4 is a schematic view of a preferred embodiment of an implantation of planned path according to the present disclosure, three traveling paths are taken as the traveling paths of three automatic harvesters.

FIG. 5 is a schematic view of a preferred embodiment of a driving mode in multiple circles pattern of the system according to the present disclosure.

FIG. 6 is a schematic view of a preferred embodiment of a driving mode in zigzag pattern of the system according to the present disclosure.

FIG. 7 is a logic schematic view of a preferred embodiment of a automatic harvester according to the present disclosure.

### DETAILED DESCRIPTION

The following description is used to disclose the present disclosure so that one skilled in the art can implement the present disclosure. The preferred embodiments in the following description are only examples, and one skilled in the art can think of other obvious variations. The basic principles of the present disclosure defined in the following description can be applied to other embodiments, modified embodiments, improvement embodiments, equivalent embodiments, and other technical solutions that do not deviate from the spirit and scope of the present disclosure.

One of ordinary skill in the art should understand that, according to the present disclosure, the orientation or position relationship indicated by the terms “longitudinal”, “lateral”, “upper”, “lower”, “front”, “rear”, “left”, “right”, “vertical”, “horizontal”, “top”, “bottom”, “inner”, “outer”, etc., is the orientation or position relationship shown in the drawings, which is convenient for describing the present disclosure and simplifying the description, rather than indicating or implying that the referred device or component must have a specific orientation, be constructed and operated in a specific orientation, the above terms should not be understood as limiting the present disclosure.

It can be understood that, the term “a” should be understood as “at least one” or “one or more”, that is, in one embodiment, the number of a component may be one, and in another embodiment, the number of the component may also be multiple, the term “one” cannot be understood as a restriction on the number.

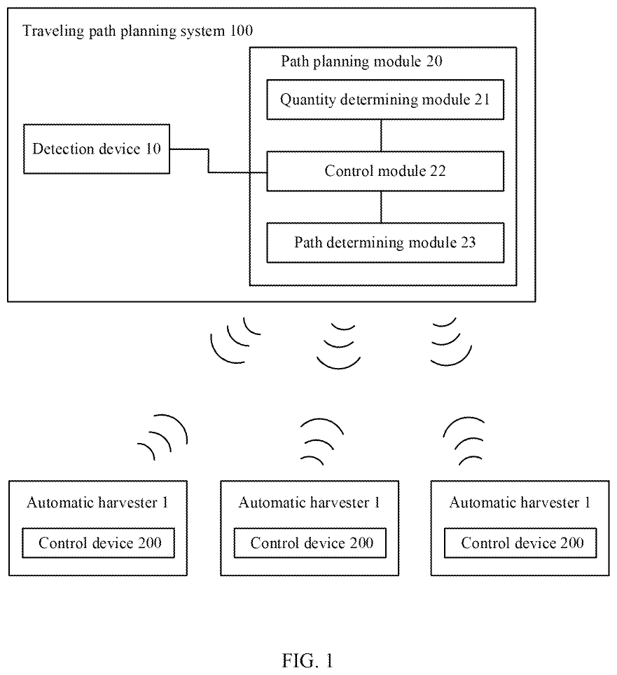

Referring to FIGS. 1-6, a system and a method for planning traveling path of multiple automatic harvesters are illustrated according to a first preferred embodiment of the present disclosure, which enables multiple automatic harvesters 1 to operate at the same time. A traveling path planning system 100 plans the traveling path of each of the automatic harvesters 1, and the planning of the traveling path takes into account conditions of various farms or fields, and problem of operation assignment of multiple automatic harvesters 1, so as to achieve better harvesting efficiency, and avoid mutual influence of the automatic harvesters 1 while operating, such as collision with each other or leaving unharvested areas. Further, the traveling path planning system 100 analyzes and plans according to a size, a shape, and features of farmland or fields, and the multiple automatic harvesters 1, so that each of the automatic harvesters 1 has an optimal traveling path. Further, the traveling path planning system 100 is adapted to the multiple automatic harvesters 1 to plan traveling paths of the multiple automatic harvesters 1 in advance. In particular, the traveling path planning system 100 is not only adapted to the harvesters, but also adapted to various agricultural machines such as rice transplanters, planting machines, transplanters, tillers, soil preparation machines, etc., which are not a limitation of the present disclosure. In addition, the traveling path planning system 100 can be arranged in each of the automatic harvesters, a remote control, a smart phone, a radio remote control, or a smart tablet host device.

In the preferred embodiment of the present disclosure, the traveling path planning system 100 includes a detection device 10 and a path planning module 20. The detection device 10 is connected with the path planning module 20. It is worth mentioning that, the above-mentioned connection mode can be a wired connection or an wireless connection, which is not a limitation of the present disclosure. Further, the detection device 10 is used to acquire basic farmland information, such as an area, a shape, and a crop category of the farmland or field. The area or the shape is a field range to be harvested by the multiple automatic harvesters 1. The path planning module 20 includes a quantity determining module 21 and a control module 22. The quantity determining module 21 is connected with the control module 22. The quantity determining module 21 is used to determine the quantity of the automatic harvesters 1 and transmit quantity determining information to the control module 22. The detection device 10 is connected with the control module 22, and is used to transmit the basic farmland information to the control module 22. Further, the control module 22 divides a harvesting area of each automatic harvester 1 according to the quantity of the automatic harvesters 1 and the basic farmland information, plans the traveling path of each automatic harvester 1, and transmits the traveling path to a control device 200 of each automatic harvester 1.

The word “module” as used herein, refers to logic embodied in hardware or firmware, or to a collection of software instructions, written in a programming language, such as, for example, Java, C, or assembly. One or more software instructions in the function modules may be embedded in firmware. It will be appreciated that the function modules may include connected logic modules, such as gates and flip-flops, and may include programmable modules, such as programmable gate arrays or processors. The function module described herein may be implemented as either software and/or hardware modules and may be stored in a storage device.

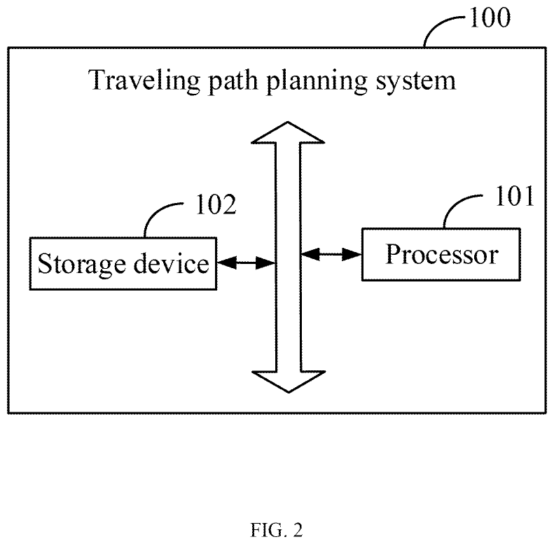

Referring to FIG. 2, in one embodiment, the traveling path planning system 100 further includes, a storage device 101 and at least one processor 102. The at least one processor 102 is used to execute a plurality of modules (e.g., modules 21-23) and other applications. The storage device 101 stores the computerized instructions of the plurality of modules, and one or more programs, such as the applications of the traveling path planning system 100. The storage device 101 can be any type of non-transitory computer-readable storage medium or other computer storage device, such as a hard disk drive, a compact disc, a digital video disc, a tape drive, a storage card (e.g., a memory stick, a smart media card, a compact flash card), or other suitable storage medium, for example. The at least one processor 102 can be a central processing unit (CPU), a microprocessor, or other data processor chip that performs functions in the traveling path planning system 100.

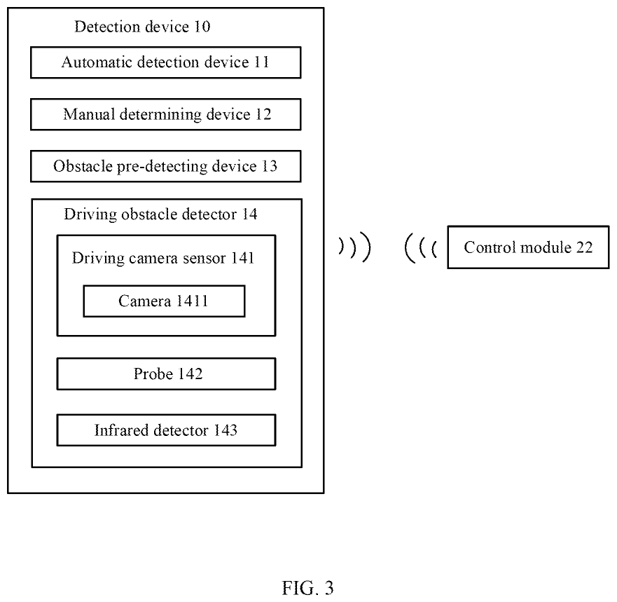

Referring to FIG. 3, in the preferred embodiment of the present disclosure, the detection device 10 includes at least one automatic detection device 11 and a manual determining device 12, the automatic detection device 11 and the manual determining device 12 are respectively connected with the control module 22 of the planning module 20. The automatic detection device 11 can be implemented to perform a fixed-point detection or a movement detection. The fixed-point detection is performed by having a number of automatic detection devices 11 respectively arranged on an corner edge of the farmland or the field, and the basic farmland information is acquired through mutual sensing of the number of automatic detection devices 11, and includes a range, a shape, coordinates, a crop category, etc. of the farmland, land, or field. The movement detection is performed by having the automatic detection device 11 arranged on an automatic harvester, an unmanned aerial vehicle, or a wireless detector, so that the automatic harvester, the unmanned aerial vehicle, or the operator can move to acquire the basic farmland information. It is worth mentioning that, the automatic detection device 11 can be implemented as an infrared sensor, a laser sensor, an ultrasonic sensor, an image sensor, or a GPS satellite positioning module, etc., which is not a limitation of the present disclosure. In addition, the manual determining device 12 pre-acquires the basic farmland information such as a range, a shape, coordinates, a crop category, etc. of the farmland, land, or field, and manually inputs the basic farmland information into the control module 22 of the path planning module 20 through the manual determining device 12. It is worth mentioning that, the control module 22 of the path planning module 20 analyzes and plans the traveling path of multiple automatic harvesters 1 (i.e., the traveling path of each automatic harvester) according to the basic farmland information acquired by the automatic detection device 11 or the manual determining device 12 and the quantity determining information determined by the quantity determining module.

In the preferred embodiment of the present disclosure, the detection device 10 further includes an obstacle pre-detecting device 13. The obstacle pre-detecting device 13 detects whether there is at least one obstacle, generates a previous obstacle information if there is at least one obstacle, and transmits the previous obstacle information to the control module 22 of the path planning module 20. It is worth mentioning that, the obstacle pre-detecting device 13 can be set to synchronously detect the at least one obstacle together with the automatic detection device 11. In other words, when the automatic detection device 11 acquires the range and shape of the land or field, the obstacle pre-detecting device 13 can synchronously acquire the previous obstacle information, so that when the path planning module 20 plans the traveling path, problem of obstacle is synchronously considered and the at least one obstacle may be avoided. In other words, the automatic detection device 11 may also be equal to the obstacle pre-detecting device 13 and simultaneously acquire the basic farmland information and the previous obstacle information. It is worth mentioning that, the control module 22 of the path planning module 20 analyzes the basic farmland information, the previous obstacle information, and the quantity determining information and plans the traveling path of each of the automatic harvesters 1. In addition, the obstacle pre-detecting device 13 can be used to distinguish differences between crops and obstacles. The previous obstacle information may include size information, image information, coordinate information, etc. of the at least one obstacle, which is not a limitation of the present disclosure. It is worth mentioning that, the obstacle pre-detecting device 13 may adopt the fixed-point detection or the movement detection which is the same as the detection method adopted by the automatic detection device 11, and the obstacle pre-detecting device 13 and the automatic detection device 11 may synchronously perform the detection method. In addition, the obstacle pre-detecting device 13 can be implemented as an infrared sensor, a laser sensor, an ultrasonic sensor, an image sensor, or a GPS satellite positioning module, etc., which is not a limitation of the present disclosure.

In the preferred embodiment of the present disclosure, the detection device 10 further includes at least one driving obstacle detector 14, which detects whether there is at least one obstacle when each automatic harvester 1 drives, further acquires driving obstacle information when the at least one obstacle is detected, and transmits the driving obstacle information to the control module 22 of the path planning module 20, when the control module 22 of the path planning module 20 receives the driving obstacle information, the control module 22 determines whether the automatic harvesters 1 in the harvesting area are required to replan the traveling path according to the driving obstacle information. Further, after the driving obstacle detector 14 of the automatic harvester 1 in the harvesting area acquires the driving obstacle information that affects a harvesting path, the driving obstacle information is transmitted to the control module 22, and the control module 22 replans the traveling path of the automatic harvester 1 in the harvesting area. The new traveling path of the automatic harvester 1 in the harvesting area will not affect the traveling path of other automatic harvesters 1. It is worth mentioning that, the driving obstacle detector 14 is arranged on the automatic harvester 1, and is optimally arranged in front of the automatic harvester 1. The encountered obstacle can be directly detected by the driving obstacle detector 14 while the automatic harvester 1 is being driven forward. In particular, when the driving obstacle detector 14 detects the obstacle, the automatic harvester 1 determines whether to replan the traveling path according to the existing basis.

In the preferred embodiment of the present disclosure, the driving obstacle detector 14 may recognize the crop and the at least one obstacle, acquire the driving obstacle information, such as the size, and transmit the size information of the at least one obstacle to the control module 22 of the path planning module 20. The control module 22 of the path planning module 20 determines whether the at least one obstacle affects the traveling path, if not, the automatic harvester 1 directly follows the initial planned traveling path, if the at least one obstacle is determined to affect the traveling path, the obstacle information is transmitted to the path planning module 20 for replanning the traveling path. In particular, the driving obstacle detector 14 may acquire image features for distinguishing the difference between the crops and the at least one obstacle. It is worth mentioning that, the driving obstacle detector 14 is arranged on the automatic harvester 1 and conveniently acquires at least one forward signal, such as the crops and the at least one obstacle, while the automatic harvester 1 is being driven. The driving obstacle detector 14 includes a driving camera sensor 141, which acquires images around the automatic harvester 1 and forms a video signal. In particular, the driving camera sensor 141 includes a number of cameras 1411 surrounding the automatic harvester 1 for acquiring the images around the automatic harvester 1 and forming the video signal. The driving obstacle detector 14 further includes at least one probe 142, which is arranged in front of the automatic harvester 1 and detects whether there is at least one obstacle in front of the automatic harvester 1, such as trees, walls, large rocks, concavities, puddles, rivers, etc. The at least one probe 142 further detects the sizes or the features of various obstacles at the same time, and transmits the detection information to the control module 22 of the path planning module 20, so that the control module 22 of the path planning module 20 determines whether the automatic harvester 1 stops operating. In addition, the driving obstacle detector 14 further includes at least one infrared detector 143, which is arranged in front of the automatic harvester 1 for sensing people or animals who suddenly enter the front of the automatic harvester 1. It is worth mentioning that, after the driving obstacle detector 14 acquires the driving obstacle information, the control module 22 replans the traveling path for the automatic harvesting 1 in the harvesting area that has detected the at least one obstacle, the traveling paths of the other automatic harvestings 1 in the harvesting areas are not affected. In particular, the replanned traveling path prevents the automatic harvester 1 from colliding with each other.

In the preferred embodiment of the present disclosure, the path planning module 20 further includes a path determining module 23, which is connected with the control module 22. The path determining module 23 can determine a driving mode of each automatic harvester 1 respectively, or determine the driving mode of the multiple automatic harvesters 1 to a same driving mode. The driving mode includes driving modes in a multiple circles pattern, a zigzag pattern, a shortest path, an optimal path, loop inward from periphery etc. A user or an operator of the automatic harvester 1 can determine the driving mode of each of the automatic harvesters 1 according to the shape of the field or farmland. As reference sets, the multiple circles pattern can be adopted if the field or farmland is square, the zigzag pattern can be used if the field or farmland is rectangular, the shortest path can be adopted for reducing harvesting time, the optimal path can be adopted if considering landform, harvesting efficiency, and program setting. The various determining methods mentioned above are suggested methods and are not limitations of the present disclosure.

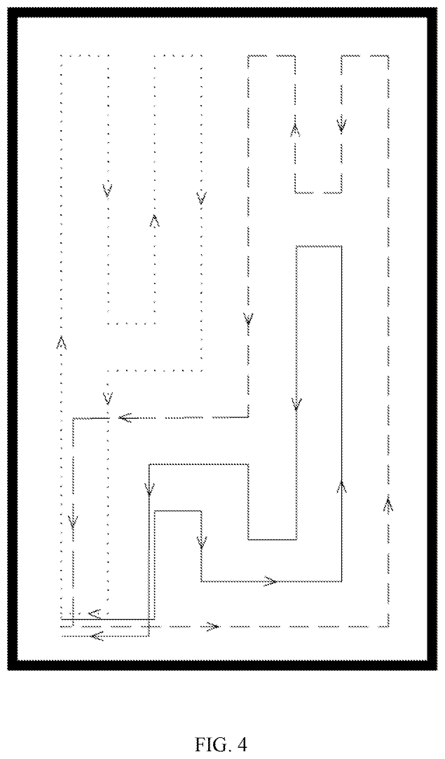

In particular, as illustrated in FIG. 4, the present disclosure provides an implementation of a planned path, which is applicable to three automatic harvesters. In FIG. 4, the outer thick line represents edges of the field or farmland, the three line types in the figure represent three traveling paths, which are adopted as the traveling paths of the three automatic harvesters 1, and the arrow on the line indicates the driving direction. In this embodiment, the initial driving points are determined to be the same, and the three automatic harvesters 1 return to the initial travel points after harvesting. The traveling path planning in this embodiment can be used as a reference, and it is not the only way of implementation, which is not a limitation of the present disclosure.

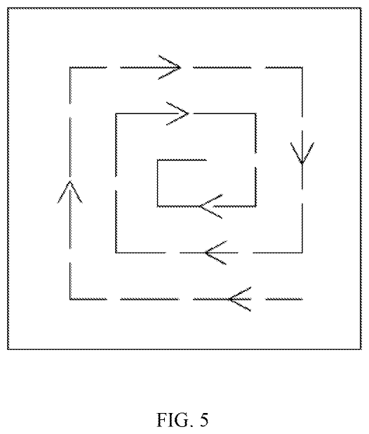

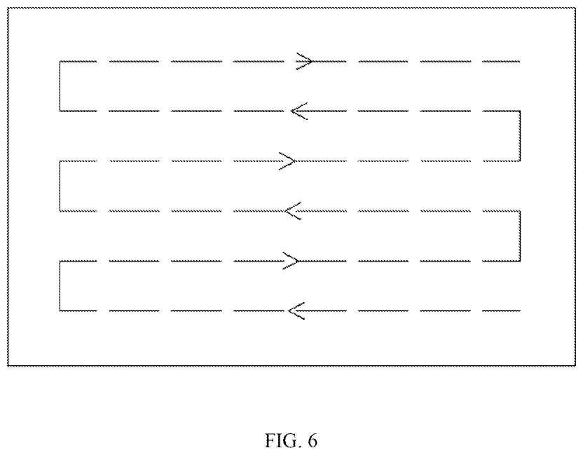

In addition, referring to FIG. 5, a schematic diagram of the traveling path in the multiple circles pattern is illustrated, the automatic harvester 1 drives as indicated by the dashed line and the arrow, the dashed line represents the traveling path of the automatic harvester, and the arrow represents the driving direction of the automatic harvester. Referring to FIG. 6, a schematic diagram of the traveling path in the zigzag pattern is illustrated, the automatic harvester 1 drives as indicated by the dashed line and the arrow. Understandably, the zigzag pattern indicates that the automatic harvesters 1 drives back and forth in rows. Therefore, if the field or farmland has any shape which is not rectangular, the driving mode in the zigzag pattern can also be selected. That is, when the automatic harvester 1 drives to a boundary of one row, the automatic harvester 1 turns and drives to another row, and when driving to the boundary, the automatic harvester 1 turns and drives again in the same manner. In addition, the driving mode of the shortest path or the optimal path is a smart set, if the user or operator of the automatic harvester selects such mode, the path planning module 20 plans the shortest path or the optimal path according to all option content. It can be understood that, the shortest path is the least path that the automatic harvester 1 drives in the entire field, and the optimal path is planned after considering the overall situation. In addition, not all fields or farmlands are completely rectangular or square, but usually have many irregular shapes. In this case, besides selecting the driving mode in the zigzag pattern, the shortest path, or the optimal path, the driving mode of loop inward from periphery can also be selected. The driving mode of loop inward from periphery is to drive inward in circles directly according to the boundary shape of the field. In other words, the driving mode of loop inward from periphery is similar to driving mode in the multiple circles pattern, and the difference lies in the shape of the farmland.

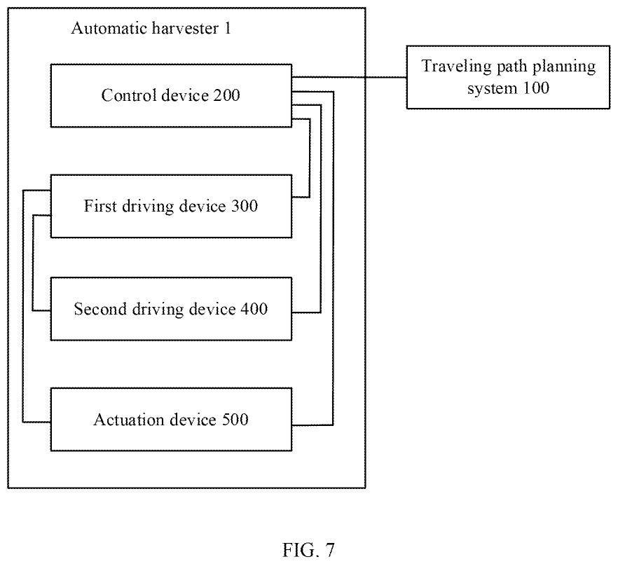

It is worth mentioning that, as illustrated in FIG. 7, each of the automatic harvesters 1 includes a control device 200, a first driving device 300, a second driving device 400, and an actuation device 500. The traveling path planning system 100 is a path planning system for multiple automatic harvesters 1, in which each component can be arranged on the automatic harvester 1 or independently according to requirements, which is not a limitation of the present disclosure. The traveling path planning system 100 is connected with the control device 200 and transmits the planned traveling path to the control device 200, so that each automatic harvester 1 follows the traveling path planned by the traveling path planning system 100. It is worth mentioning that, the connection mode between the traveling path planning system 100 and the control device 200 may adopt a wired or wireless connection mode according to actual settings, which is not a limitation of the present disclosure. In addition, the first driving device 300, the second driving device 400, and the actuation device 500 are each connected with the control device 200. It is understandable that, the control device 200 can be a central control system of the automatic harvester 1, which integrates and controls of various devices of the automatic harvester 1. The first driving device 300 is connected with the actuation device 500, the second driving device 400, and the control device 200, and provides power for the actuation device 500, the second driving device 400, and the control device 200. The first driving device 300 is controlled by the control device 200 to drive various components to perform corresponding operations. It is worth mentioning that, the first driving device 300 can be implemented as a fuel, electric, or hybrid drive, which is not a limitation of the present disclosure. The second driving device 400 is used to drive the automatic harvester 1 to move, such as crawler moving, two-wheel moving, or four-wheel moving. The actuation device 500 is used to perform harvesting operations, such as cutting. The traveling path planning system 100 is used to provide traveling paths of the multiple automatic harvesters 1.

In addition, a method for planning traveling paths of multiple automatic harvesters provided by the present disclosure is described. The method for planning traveling paths of multiple automatic harvesters includes the following steps:

(a) a detection device 10 detects and forms basic farmland information; and

(b) after the basic farmland information is received and quantity determining information is determined, a path planning module 20 divides a harvesting area of multiple automatic harvesters 1 and the traveling path of each of the multiple automatic harvester 1.

In step (a), the basic farmland information includes information such as a size, an area, a shape, coordinates, and a crop category of the farmland.

In step (a), the basic farmland information is acquired by an automatic detection device 11 through a fixed-point detection or a movement detection. In particular, the automatic detection device 11 may be combined with the automatic harvesters, an unmanned aerial vehicle, or a wireless detector to acquire the basic farmland information. In addition, the automatic detection device 11 may be implemented as an infrared sensor, a laser sensor, an ultrasonic sensor, an image sensor, or a GPS satellite positioning module.

In step (a), the basic farmland information is manually input through a manual determining device 12.

In step (a), an obstacle pre-detecting device 13 is used to detect whether there is at least one obstacle, and generate previous obstacle information. In particular, the obstacle pre-detecting device 13 detects together with the automatic detection device 11. Further, in step (a), in addition to generating the basic farmland information, if there is at least one obstacle, the previous obstacle information can also be generated at the same time. Both the basic farmland information and the obstacle information are transmitted to a control module 22 of the path planning module 20, and the control module 22 of the path planning module 20 performs analysis and path planning.

In step (b), the traveling path of each automatic harvester 1 has an initial driving point, each initial driving point may be the same or different. In other words, the multiple automatic harvesters 1 may all start harvesting from a same place or different places. It is worth mentioning that, the initial travel point is a starting point of the traveling path of each automatic harvester 1.

In step (b), the quantity of harvesting areas is equal to the quantity of automatic harvesters 1. For example, assuming that there are four automatic harvesters 1, the quantity of harvesting areas is four.

In step (b), a quantity determining module 21 is used to determine the quantity of the automatic harvesters 1.

In step (b), the total of each of the harvesting areas is equal to the total farmland area.

In step (b), the traveling paths of the automatic harvesters 1 are not to be disturbed by each other.

In step (b), a path determining module 23 is used to determine the driving mode of each automatic harvester and generate driving information. The driving information includes information such as a multiple circles pattern, a zigzag pattern, a shortest path, an optimal path, and loop inward from periphery. In particular, the multiple automatic harvesters 1 can define same or different driving modes, which is not a limitation of the present disclosure.

In particular, when each of the automatic harvesters 1 acquires respective traveling path according to the method for planning traveling paths, and each of the automatic harvesters 1 drives in the respective harvesting area according to the respective traveling path, a driving obstacle detector 14 of each detection device 10 simultaneously detects at least one obstacle during driving, when at least one obstacle is detected, driving obstacle information is generated and transmitted to the control module 22 of the path planning module 20. The control module 22 of the path planning module 20 determines an operation mode of the automatic harvester 1 according to the driving obstacle information, such as stopping immediately, keeping driving, or replanning the traveling path. In particular, the control module 22 of the path planning module 20 can control the automatic harvester 1 to stop immediately, replan the traveling path immediately, and re-activate the automatic harvester 1 after completing the new traveling path planning. It is worth mentioning that, two and above automatic harvesters 1 appearing in a detection area of the respective driving obstacle detectors 14 can also be detected, so as to further avoid collision of the automatic harvesters 1.

One of ordinary skill in the art should understand that, the above description and the embodiments of the present disclosure shown in the drawings are only examples and do not limit the present disclosure. The purpose of the present disclosure has been completely and effectively achieved. The functions and structural principles of the present disclosure have been shown and explained in the embodiments. Without departing from the principles, the embodiments of the present disclosure may have any deformation or modification.

What is claimed is:

1. A method for planning traveling paths of multiple automatic harvesters, comprising:
detecting and forming basic farmland information by a detection device; and
dividing a harvesting area and forming a traveling path for each of the multiple automatic harvesters after the basic farmland information is received and quantity determining information is determined.

2. The method according to claim 1, further comprising:
transmitting the traveling path for each of the multiple automatic harvesters to a control device of each of the multiple automatic harvesters.

3. The method according to claim 1, wherein the basic farmland information is an information group formed by a size, an area, a shape, coordinates, and a crop category of a farmland.

4. The method according to claim 1, wherein detecting and forming basic farmland information by a detection device comprises:
acquiring the basic farmland information by an automatic detection module through a fixed-point detection or a movement detection.

5. The method according to claim 4, wherein the automatic detection module is a module formed by an infrared sensor, a laser sensor, an ultrasonic sensor, an image sensor, or a GPS satellite positioning module.

6. The method according to claim 1, wherein dividing a harvesting area and forming a traveling path for each of the multiple automatic harvesters further comprising:
detecting whether there is at least one obstacle; and
generating previous obstacle information.

7. The method according to claim 1, wherein the traveling path for each automatic harvester has an initial driving point, each initial driving point is the same or different.

8. The method according to claim 1, wherein dividing a harvesting area and forming a traveling path for each of the multiple automatic harvesters further comprising:
determining a quantity of the multiple automatic harvesters.

9. The method according to claim 1, wherein the traveling paths of the multiple automatic harvesters are not to be affected by each other.

10. The method according to claim 1, wherein dividing a harvesting area and forming a traveling path for each of the multiple automatic harvesters further comprising:
determining a driving mode of each automatic harvester and generating driving information.

11. The method according to claim 1, further comprising:
generating driving obstacle information in response that at least one obstacle is detected while the automatic harvesters are driving.

12. A system for planning traveling paths of multiple automatic harvesters, comprising:
a detection device acquiring basic farmland information; and
a path planning module comprising a quantity determining module and a control module, wherein the quantity determining module is connected with the control module and transmits quantity determining information to the control module,
wherein the control module divides a harvesting area and forms a traveling path for each of the multiple automatic harvesters according to the basic farmland information and the quantity determining information.

13. The system according to claim 12, wherein the basic farmland information is an information group formed by a size, an area, a shape, coordinates, and a crop category of a farmland.

14. The system according to claim 12, wherein the detection device comprises:
an automatic detection module connected with the control module, wherein the automatic detection module acquires the basic farmland information through a fixed-point detection or a movement detection, and transmits the basic farmland information to the control module.

15. The system according to claim 14, wherein the automatic detection module is arranged on the automatic harvesters, an unmanned aerial vehicle, or a wireless detector, to perform movement detection.

16. The system according to claim 14, wherein the automatic detection module is a module formed by an infrared sensor, a laser sensor, an ultrasonic sensor, an image sensor, or a GPS satellite positioning module.

17. The system according to claim 12, wherein the detection device comprises:
at least one manual determining module connected with the control module and input the basic farmland information into the control module.

18. The system according to claim 12, wherein the detection device comprises:
at least one obstacle pre-detecting device connected with the control module for acquiring previous obstacle information through a fixed-point detection or a movement detection, and transmitting the previous obstacle information to the control module.

19. The system according to claim 12, wherein the detection device comprises:
at least one driving obstacle detector connected with the control module, arranged on the automatic harvester, for acquiring driving obstacle information in response that at least one obstacle is detected while the automatic harvester is driving, and transmitting the driving obstacle information to the control module.

20. The system according to claim 19, wherein the at least one driving obstacle detector comprises a driving camera sensor, which comprises a plurality of cameras surrounding the automatic harvester for acquiring images around the automatic harvester.

21. The system according to claim 19, wherein the at least one driving obstacle detector comprises at least one probe, which is arranged in front of the automatic harvester and detects whether there is at least one obstacle in front of the automatic harvester.

22. The system according to claim 19, wherein the at least one driving obstacle detector comprises at least one infrared detector, which is arranged in front of the automatic harvester for sensing people or animals who suddenly enter the front of the automatic harvester.

23. The system according to claim 12, wherein the system is arranged on at least one of the multiple automatic harvesters, a remote control, a smart phone, a radio remote control, or a smart tablet host device.
